(19) United States
(12) Patent Application Publication
(10) Pub. No.: US 2023/0319248 A1
(43) Pub. Date: Oct. 5, 2023

(54) METHOD FOR SWITCHING ATLAS ACCORDING TO USER'S WATCHING POINT AND DEVICE THEREFOR

(71) Applicant: Electronics and Telecommunications Research Institute, Daejeon (KR)

(72) Inventors: Gwang Soon LEE, Daejeon (KR); Sang Woon KWAK, Daejeon (KR); Hong Chang SHIN, Daejeon (KR)

(73) Assignee: Electronics and Telecommunications Research Institute, Daejeon (KR)

(21) Appl. No.: 18/192,471

(22) Filed: Mar. 29, 2023

(30) Foreign Application Priority Data
Mar. 29, 2022 (KR) 10-2022-0038560
Mar. 27, 2023 (KR) 10-2023-0039984

(51) Int. Cl. H04N 13/117; H04N 13/194; H04N 19/597

(52) U.S. Cl. CPC H04N 13/117; H04N 13/194; H04N 19/597

(57) ABSTRACT

A method of switching an atlas according to a watching position according to the present disclosure includes acquiring information on a view image required to reproduce a viewport image; acquiring information of a first atlas mapped to the view image; and receiving a bitstream of the first atlas and a bitstream of a second atlas different from the first atlas. In this case, when it is determined that atlas switching is necessary, reception of any one of a bitstream of the first atlas and a bitstream of the second atlas may be stopped and a bitstream of a third atlas may be newly received.

### FIELD OF INVENTION

The present disclosure relates to a method for encoding/decoding an immersive video which supports motion parallax for a rotation and translation motion.

### BACKGROUND OF THE INVENTION

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6DoF omnidirectional image is actively under way.

### DISCLOSURE

### Technical Problem

A purpose of the present disclosure is to provide a method for reproducing a viewport image by receiving only part of a plurality of bitstreams and a device therefor.

A purpose of the present disclosure is to provide a seamless viewport image by switching a received bitstream according to a watching position.

Technical purposes obtainable from the present disclosure are non-limited to the above-mentioned technical purposes, and other unmentioned technical purposes may be clearly understood from the following description by those having ordinary skill in the technical field to which the present disclosure pertains.

### Technical Solution

A method of switching an atlas according to a watching position according to the present disclosure includes obtaining information on a view image required to reproduce a viewport image; obtaining information of a first atlas mapped to the view image; and receiving a bitstream of the first atlas and a bitstream of a second atlas different from the first atlas. In this case, when it is determined that atlas switching is necessary, reception of any one of a bitstream of the first atlas and a bitstream of the second atlas may be stopped and a bitstream of a third atlas may be newly received.

A device which switches an atlas according to a watching position according to the present disclosure includes a MIV decoder which obtains information on a view image required to reproduce a viewport image and obtains information of a first atlas mapped to the view image; and a bitstream reception unit which receives a bitstream of the first atlas and a bitstream of a second atlas different from the first atlas. In this case, when it is determined that atlas switching is necessary, reception of any one of a bitstream of the first atlas and a bitstream of the second atlas may be stopped and a bitstream of a third atlas may be newly received.

In a method and a device of switching an atlas according to a watching position according to an embodiment of the present disclosure, the second atlas is a neighboring atlas neighboring the first atlas, and the neighboring atlas may include a second view image which is spatially adjacent to a first view image included in the first atlas.

In a method and a device of switching an atlas according to a watching position according to an embodiment of the present disclosure, when there are a plurality of neighboring atlases for the first atlas, one of the plurality of neighboring atlases may be selected as the second atlas based on a spatial position of a view image corresponding to the viewport image.

In a method and a device of switching an atlas according to a watching position according to an embodiment of the present disclosure, the third atlas may neighbor an atlas in which reception is not stopped and may not neighbor an atlas in which reception is stopped among the first atlas and the second atlas.

In a method and a device of switching an atlas according to a watching position according to an embodiment of the present disclosure, whether the switching is required may be determined based on at least one of moving speed of a viewer, rotational speed of a viewer, a spatial interval between view images or the number of view images in an atlas.

In a method and a device of switching an atlas according to a watching position according to an embodiment of the present disclosure, a bitstream of the first atlas to a third atlas may be received from an edge server, and the number of bitstreams received by the edge server from a transmission server may be greater than the number of bitstreams provided by the edge server to a terminal.

In a method and a device of switching an atlas according to a watching position according to an embodiment of the present disclosure, a bitstream of the first atlas to a third atlas may be received by a transmission client in a terminal, and the number of bitstreams provided by the transmission client to an image decoder may be smaller than the number of bitstreams received by the transmission client.

In a method and a device of switching an atlas according to a watching position according to an embodiment of the present disclosure, a mapping relation between view images and atlases may be periodically updated.

In a method and a device of switching an atlas according to a watching position according to an embodiment of the present disclosure, mapping information on more atlases than the number of atlases decoded by a terminal may be stored in the terminal, and the mapping information may be information on a view image included in an atlas per atlas.

Technical purposes obtainable from the present disclosure are non-limited to the above-mentioned technical purposes, and other unmentioned technical purposes may be clearly understood from the following description by those having ordinary skill in the technical field to which the present disclosure pertains.

### Technical Effects

According to the present disclosure, there is an effect of reducing the amount of data received in a terminal.

According to the present disclosure, there is an effect of providing a seamless viewport image by switching a received bitstream.

Effects achievable by the present disclosure are not limited to the above-described effects, and other effects which are not described herein may be clearly understood by those skilled in the pertinent art from the following description.

### DESCRIPTION OF DIAGRAMS

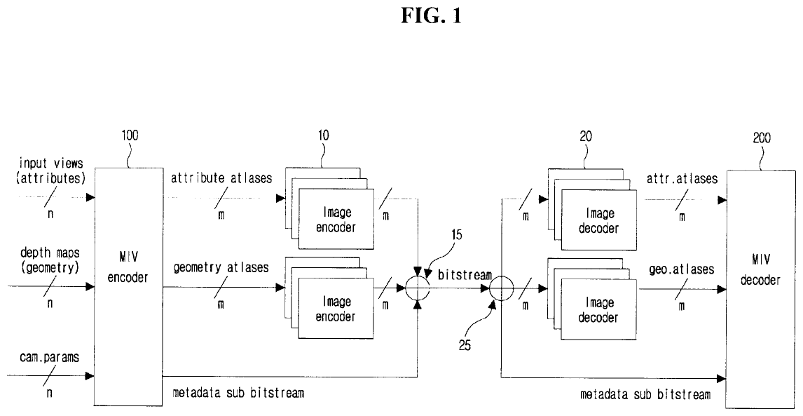

FIG. 1 is a conceptual diagram of an immersive video service.

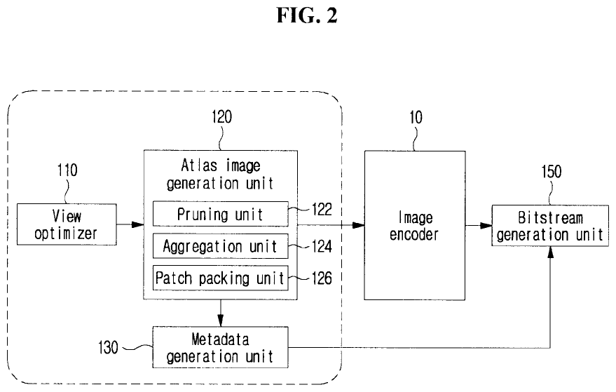

FIG. 2 is a block diagram of a MIV encoder 100 disclosed in FIG. 1.

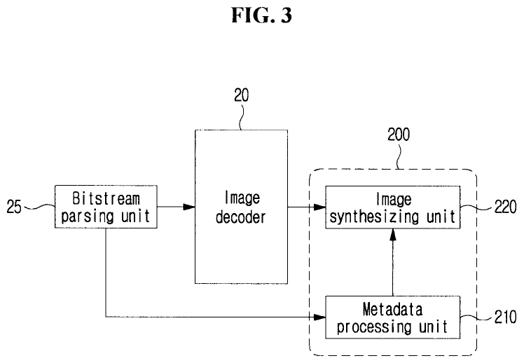

FIG. 3 is a block diagram of a MIV decoder 200 shown in FIG. 1.

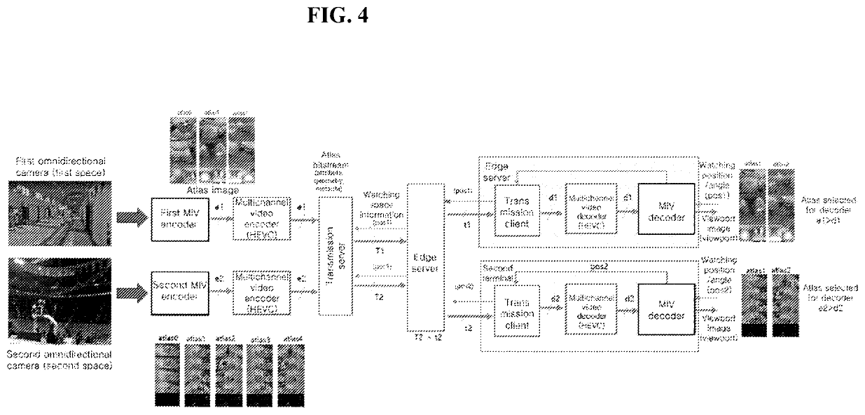

FIG. 4 is a conceptual diagram for immersive video transmission and reception according to an embodiment of the present disclosure.

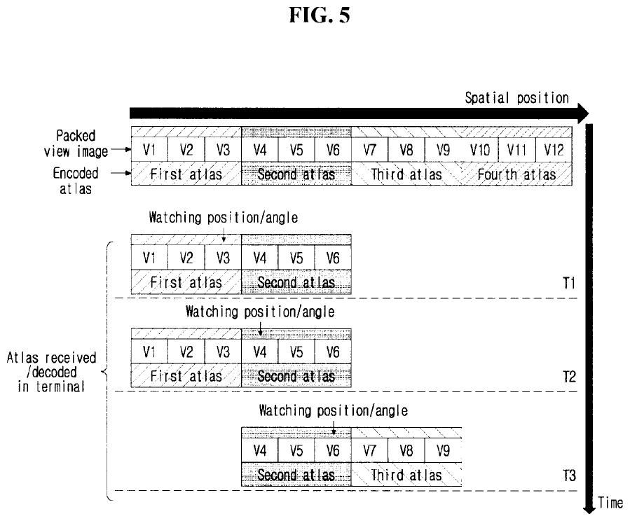

FIG. 5 is intended to describe a method of reproducing a viewport image seamlessly according to a viewer's movement according to an embodiment of the present disclosure.

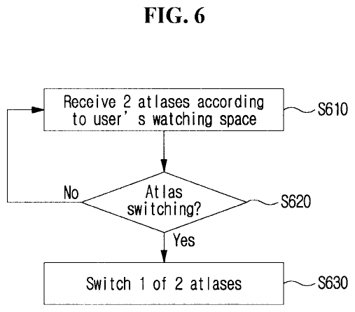

FIG. 6 is a flow chart of an atlas switching method according to an embodiment of the present disclosure.

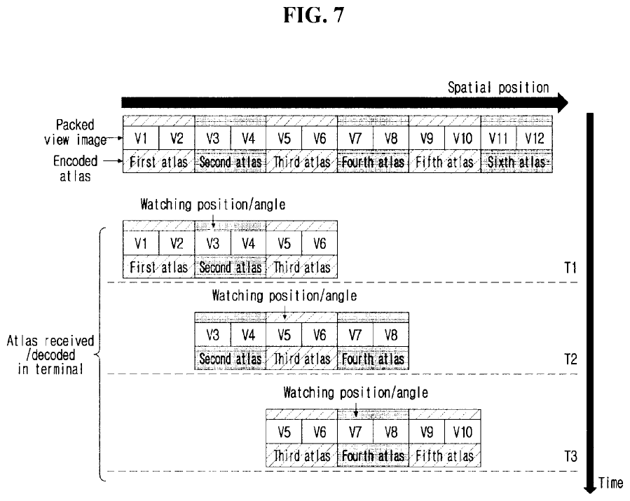

FIG. 7 is intended to describe a method of reproducing a viewport image seamlessly according to a viewer's movement according to an embodiment of the present disclosure.

### DETAILED EMBODIMENTS

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's watching position is changed, refers to an image that a viewport may be also dynamically changed. In order to implement an immersive video, a plurality of input images are required. Each of a plurality of input images may be referred to as a source image or a view image. A different view index may be assigned to each view image.

An immersive video may be classified into 3DoF (Degree of Freedom), 3DoF+, Windowed-6DoF or 6DoF type, etc. A 3DoF-based immersive video may be implemented by using only a texture image. On the other hand, in order to render an immersive video including depth information such as 3DoF+ or 6DoF, etc., a depth image (or, a depth map) as well as a texture image is also required.

It is assumed that embodiments described below are for immersive video processing including depth information such as 3DoF+ and/or 6DoF, etc. In addition, it is assumed that a view image is configured with a texture image and a depth image.

FIG. 1 is a conceptual diagram of an immersive video service.

As an omnidirectional camera is intended to acquire multiple view images required for spatial stereo-scopic image reproduction, it is composed of a plurality of cameras which can be distinguished based on a physical or computer graphic.

A MIV (MPEG Immersive Video) encoder 100 receives geometry information including a texture image corresponding to a color image, a geometry image corresponding to a depth image and an internal/external camera parameter from multiple view images acquired through an omnidirectional camera. A MIV encoder 100 outputs a texture atlas image and a geometry atlas image by packing multiple texture images and geometry images. A texture atlas and a geometry atlas output an image of a format for video encoding and decoding.

Meanwhile, a MIV encoder 100 may extract and pack only pixel data necessary for image rendering in a MIV decoder 200 from a plurality of view images. Through it, the amount of pixel data which should be encoded and transmitted may be reduced. In addition, a camera parameter, view image information, atlas information, etc. necessary for image rendering may be generated as metadata and transmitted with image data.

A texture atlas image and a geometry atlas image output through a MIV encoder 100 are encoded through a multi-channel video encoder 10. Encoded image data and metadata is transmitted and decoded through a multi-channel video decoder 20. A MIV decoder 200 extracts and interprets metadata and separates a text image and a geometry image at a required time from a terminal. In addition, in an image synthesizing unit (or a renderer) in a MIV decoder 200, based on metadata and decoded image data, a viewport image watched by a viewer is reproduced.

FIG. 2 is a block diagram of a MIV encoder 100 disclosed in FIG. 1.

In reference to FIG. 2, a MIV encoder 100 according to the present disclosure may include a view optimizer 110, an atlas generation unit 120 and a metadata generation unit 130.

An immersive video processing device receives a plurality of pairs of images, a camera internal variable and a camera external variable as an input value to encode an immersive video. Here, a plurality of pairs of images include a texture image (Texture component/Attribute component) and a depth image (Geometry component). Each pair may have a different view. Accordingly, a pair of input images may be referred to as a view image. Each of view images may be divided by an index. In this case, an index assigned to each view image may be referred to as a view or a view index.

A camera internal variable includes a focal distance, a position of a principal point, etc. and a camera external variable includes a position, a direction, etc. of a camera. A camera internal variable and a camera external variable may be treated as a camera parameter or a view parameter.

A view optimizer 110 partitions view images into a plurality of groups. As view images are partitioned into a plurality of groups, independent encoding processing per each group may be performed. In an example, view images filmed by N spatially consecutive cameras may be classified into one group. Thereby, view images that depth information is relatively coherent may be put in one group and accordingly, rendering quality may be improved.

In addition, by removing dependence of information between groups, a spatial random access service which performs rendering by selectively bringing only information in a region that a user is watching may be made available.

Whether view images will be partitioned into a plurality of groups may be optional.

In addition, a view optimizer 110 may classify view images into a basic image and an additional image. A basic image represents an image which is not pruned as a view image with a highest pruning priority and an additional image represents a view image with a pruning priority lower than a basic image.

A view optimizer 110 may determine at least one of view images as a basic image. A view image which is not selected as a basic image may be classified as an additional image.

A view optimizer 110 may determine a basic image by considering a view position of a view image. In an example, a view image whose view position is the center among a plurality of view images may be selected as a basic image.

Alternatively, a view optimizer 110 may select a basic image based on a camera parameter. Specifically, a view optimizer 110 may select a basic image based on at least one of a camera index, a priority between cameras, a position of a camera or whether it is a camera in a region of interest.

In an example, at least one of a view image with a smallest camera index, a view image with a largest camera index, a view image with the same camera index as a predefined value, a view image filmed by a camera with a highest priority, a view image filmed by a camera with a lowest priority, a view image filmed by a camera at a predefined position (e.g., a central position) or a view image filmed by a camera in a region of interest may be determined as a basic image.

Alternatively, a view optimizer 110 may determine a basic image based on quality of view images. In an example, a view image with highest quality among view images may be determined as a basic image.

Alternatively, a view optimizer 110 may determine a basic image by considering an overlapping data rate of other view images after inspecting a degree of data redundancy between view images. In an example, a view image with a highest overlapping data rate with other view images or a view image with a lowest overlapping data rate with other view images may be determined as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124 and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to a pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of a shape of a valid region, a patch is extracted in a square shape, so a patch extracted from a square valid region may include invalid data as well as valid data.

In this case, an aggregation unit 124 may repartition a L-shaped or C-shaped patch which reduces encoding efficiency. Here, a L-shaped patch represents that distribution of a valid region is L-shaped and a C-shaped patch represents that distribution of a valid region is C-shaped.

When distribution of a valid region is L-shaped or C-shaped, a region occupied by an invalid region in a patch is relatively large. Accordingly, a L-shaped or C-shaped patch may be partitioned into a plurality of patches to improve encoding efficiency.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map or a Perspective Projection Format.

Here, an unpruned view image refers to a basic image with a highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a square image. In patch packing, deformation such as size transform, rotation, or flip, etc. of a patch may be accompanied. An image that patches are packed may be defined as an atlas.

Specifically, a packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of an arrangement structure of a camera rig, accuracy of a depth map or the number of view images.

A metadata generation unit 130 generates metadata for image synthesis. Metadata may include at least one of camera-related data, pruning-related data, atlas-related data or patch-related data.

Pruning-related data includes information for determining a pruning priority between view images. In an example, at least one of a flag representing whether a view image is a root node or a flag representing whether a view image is a leaf node may be encoded. A root node represents a view image with a highest pruning priority (i.e., a basic image) and a leaf node represents a view image with a lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

In an example, geometry scale enabled flag, a syntax representing whether it is allowed to reduce a depth atlas, may be encoded/decoded. When a value of a syntax geometry scale enabled flag is 0, it represents that it is not allowed to reduce a depth atlas. In this case, a depth atlas has the same size as a texture atlas.

When a value of a syntax geometry scale enabled flag is 1, it represents that it is allowed to reduce a depth atlas. In this case, information for determining a reduction ratio of a depth atlas may be additionally encoded/decoded. In an example, geometry scaling factor x, a syntax representing a horizontal directional reduction ratio of a depth atlas, and geometry scaling factory, a syntax representing a vertical directional reduction ratio of a depth atlas, may be additionally encoded/decoded.

An immersive video output device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

FIG. 3 is a block diagram of a MIV decoder 200 shown in FIG. 1.

In reference to FIG. 3, an immersive image output device according to the present disclosure may include a metadata processing unit 210 and an image synthesizing unit 220.

A metadata processing unit 210 unformats parsed metadata.

Unformatted metadata may be used to synthesize a specific view image. In an example, when motion information of a user is input to an immersive video output device, a metadata processing unit 210 may determine an atlas necessary for image synthesis and patches necessary for image synthesis and/or a position/a size of the patches in an atlas and others to reproduce a viewport image according to a user's motion.

An image synthesizing unit 220 may dynamically synthesize a viewport image according to a user's motion. Specifically, an image synthesizing unit 220 may extract patches required to synthesize a viewport image from an atlas by using information determined in a metadata processing unit 210 according to a user's motion. Specifically, a viewport image may be generated by extracting patches extracted from an atlas including information of a view image required to synthesize a viewport image and the view image in the atlas and synthesizing extracted patches.

Meanwhile, an image encoder 10 of FIG. 1 encodes a texture atlas and a depth atlas output from a MIV encoder. Image encoding may be performed based on a codec such as AVC, HEVC, VVC, AV1, etc.

A bitstream generation unit 15 of FIG. 1 generates a bitstream based on encoded image data and metadata. A generated bitstream may be transmitted to an immersive image output device.

A bitstream parsing unit 25 of FIG. 1 parses image data and metadata from a bitstream. Image data may include data of an encoded atlas. When a random spatial access service is supported, only a partial bitstream including a watching position of a user may be received.

An image decoder 20 of FIG. 1 decodes parsed image data. Specifically, an image decoder 20 may include a texture image decoder for decoding a texture atlas and a depth image decoder for decoding a depth atlas. Image decoding may be performed based on a codec such as AVC, HEVC, VVC, AV1, etc.

Meanwhile, an image encoder groups input view images into a plurality of groups and each of grouped view images may be processed in parallel by a plurality of encoders (i.e., group encoders). Encoding through such a group encoder has a purpose of enabling decoding in a unit of a group in an image decoder, while separating and processing view images into a plurality of groups to increase encoding speed when consistency of a texture or depth value between view images is low.

In this case, grouping of view images may be performed based on the predetermined number of view units or similarity between view images, etc.

Meanwhile, a MIV encoder 100, an image encoder 10 and a bitstream generation unit 10 shown in FIG. 1 may configure one device or some of them may be configured with separate devices. Similarly, a MIV decoder 200, an image decoder 20 and a bitstream parsing unit 25 may configure one device or some of them may be configured with separate devices.

In an example described later, it is assumed that a MIV decoder 200, an image decoder 20 and a bitstream parsing unit 25 configure one terminal. Here, a terminal, as a device which outputs an image reproduced based on image decoding and decoded data, may be an electronic device capable of computing such as a Head Mount Display (HMD), a smart device, a computer, etc.

A purpose of a traditional immersive video service is to reproduce and provide a viewport image to a viewer in a seating environment. But, with the development of processing and transmission speed, when a viewer moves in an indoor and outdoor space, there is a need for an immersive video service which can seamlessly support a wide range of immersive videos, and accordingly, an improved encoding/decoding and rendering method is required.

FIG. 4 is a conceptual diagram for immersive video transmission and reception according to an embodiment of the present disclosure.

For immersive image reproduction, data for a plurality of spaces may be acquired. Data for a plurality of spaces may be input to a plurality of MIV encoders. In this case, data of each of a plurality of spaces may be provided as an input view of a different MIV encoder. In an example, in an example shown in FIG. 4, each data for space 1 and space 2 may be acquired through a different omnidirectional camera, and data for space 1 and data for space 2 may be provided as an input view of a first MIV encoder and a second MIV encoder, respectively. Here, data input to a MIV encoder may include a texture image, a geometry image and geometry information.

Meanwhile, after grouping a texture image and a geometry image output from omnidirectional cameras by using geometry information, grouped data may be input to each of MIV encoders operating as a group MIV encoder. By inputting grouped data to each of MIV encoders, an atlas image which can be rendered in an mutually independent way (i.e., a texture atlas and a geometry atlas) may be output.

The number of atlas images output from a plurality of MIV encoders may be dependent on at least one of a scope of a space, a structure of an omnidirectional camera (e.g., at least one of the number or interval of cameras) or quality of a geometry image or geometry information. In an example, as a scope of a space covered by data gets wider, or as quality of a geometry image and/or geometry information gets worse, the number of atlases output from a plurality of MIV encoders increases.

The number of atlases may be configured with the number which is the same as or smaller than the number of image encoders. A bitstream output from multi-channel image encoders may be multiplexed through a transmission server and may be transmitted to a plurality of users through a transmission network. In this case, a transmission protocol such as DASH, etc. may be applied to a bitstream.

In a terminal, when a space to be watched is selected by a user, a viewport image corresponding to a selected space is rendered. Specifically, when a position and/or an angle to be watched is selected through a HMD or a smart device, etc., a bitstream required to reproduce a viewport image may be selected and decoded, and a viewport image may be reproduced based on decoded data.

Meanwhile, when the size and/or number of atlases output from a MIV encoder increases, the capacity of a bitstream increases. According to a transmission capability/environment, a case may occur in which a terminal cannot reproduce a viewport image in real time by receiving a bulk bitstream.

In order to resolve the problem, the present disclosure proposes a method of transmitting information on a space to be watched (pos1, pos2) to a server end and receiving only a partial bitstream (t1, t2) required to decode a position corresponding to it in each of terminals. In other words, if part of a bitstream is selectively received, a terminal may reproduce a viewport image at a position wanted by a viewer only by receiving a bitstream with a relatively small capacity. In an example, in an example shown in FIG. 4, 3 atlases are output in a first MIV encoder, but it was illustrated that a first terminal reproduces a viewport image by using only 2 atlases of them. Likewise, 4 atlases are output in a second MIV encoder, but it was illustrated that a second terminal reproduces a viewport image by using only 2 atlases of them.

In other words, a terminal may selectively receive a bitstream that an atlas required to reproduce a viewport image is encoded among a plurality of bitstreams. The selective reception may be performed in a server end which transmits a bitstream to a terminal such as a transmission server, or an edge server, etc.

In another example, through a transmission client in a terminal (i.e., a bitstream reception unit), selective reception may be also implemented. In an example, when information on a watching space of a user is input to a transmission client, a transmission client may selectively input to a video decoder only a partial bitstream corresponding to the watching space among bitstreams received from the outside.

Meanwhile, for selective reception of a bitstream, information transmitted to a transmission client or a server end in a MIV decoder may include information on a watching space (e.g., at least one of a watching position or angle) or information for selecting an atlas required to generate a viewport image corresponding to a watching space (e.g., at least one of information of a view image included in an atlas, camera parameter information for each view image and depth scope information for all atlas identifiers transmitted or each atlas identifier).

As described above, a terminal may selectively receive and decode only a partial bitstream of multiplexed bitstreams. As an embodiment which may be applied by being combined with or separated from the embodiment, only a decoded image required to reproduce a viewport image among data which is decoded and output in an image decoder may be provided for a MIV decoder. In an example, a terminal may receive a bitstream including an atlas which is not required to reproduce a viewport image as well as a bitstream including an atlas which is required to reproduce a viewport image, and decode a plurality of bitstreams received through an image decoder. But, only an atlas required to reproduce a viewport image among a plurality of reconstructed atlases may be selectively transmitted to a MIV decoder.

For it, an atlas selection unit (not shown in a drawing) which selects one of reconstructed atlases may be inserted as an additional component between an image decoder and a MIV decoder. An atlas selection unit may receive at least one of information identifying an atlas required to reproduce a viewport image or a watching space of a user, and select an atlas corresponding to received information among reconstructed atlases to transmit it to a MIV decoder.

Meanwhile, the number and/or size of atlases available for decoding and rendering in a terminal may be limited according to a hardware and/or software resource.

FIG. 5 is intended to describe a method of reproducing a viewport image seamlessly according to a viewer's movement according to an embodiment of the present disclosure.

In FIG. 5, each of V1 to V12 represents multiview images acquired from omnidirectional cameras. Each of V1 to V12 may be configured with a set of texture images and geometry images. In addition, it is assumed that V1 to V12 are acquired from omnidirectional cameras arranged in a horizontal direction and it is assumed that a x-axis represents a spatial position.

An atlas image may be configured by packaging a plurality of view images. In an example, in an example shown in FIG. 5, it was shown that each atlas is configured by packaging 3 view images.

A terminal may receive only a bitstream that an atlas required to reproduce a viewport image is included. In other words, N atlases are encoded in a transmission side to generate N bitstreams, whereas a terminal may select and receive fewer bitstreams than N. In other words, a terminal may reproduce a viewport image by receiving fewer atlases than N.

In an example, at a T1 view, when a space that a user tries to watch is a V3 view, a second atlas, a neighboring atlas of a first atlas, as well as a first atlas including a V3 view may be received together.

According to the passage of time, when a space to be watched is changed, an atlas required to reproduce a viewport image may be also changed. In an example, at a T1 view, when a space to be watched is a V3 view, a viewport image may be generated by using a first atlas. On the other hand, when a space to be watched at a T2 view is changed into a V4 space, a viewport image should be generated by using a second atlas.

In addition, when a space to be watched at a T3 view is changed into a V6 view, a viewport image may be generated by using a second atlas.

As above, considering that a position that a user tries to watch may be changed in real time, a terminal may additionally receive not only an atlas including a view image to be reproduced, but also an atlas neighboring it. Here, a neighboring atlas refers to an atlas including a neighboring view image of a view image included in a required atlas.

Meanwhile, according to a position of view images, 2 neighboring atlases may exist in one atlas. In an example, in an example shown in FIG. 5, a second atlas neighbors a first atlas on the left and neighbors a third atlas on the right. In this case, one of 2 neighboring atlases may be selected based on a position of a view image corresponding to a current watching space.

In an example, if a viewport image is positioned on the left from a middle point of V5, a terminal may select and receive a first atlas and a second atlas. On the other hand, if a viewport image is positioned on the right from a middle point of V5, a terminal may select and receive a second atlas and a third atlas. As a result, as a watching space of a user is changed from the left to the right, receiving a first atlas and a second atlas (a T1 and T2 view) may be changed into receiving a second atlas and a third atlas. In other words, according to a watching position of a user, 1 atlas of 2 atlases may be switched. While a switched atlas (i.e., a third atlas) spatially neighbors a non-switched atlas (i.e., a second atlas), it does not spatially neighbor an atlas which is switched and removed (i.e., a first atlas).

As a result, a neighboring atlas may be selected so that a watching space of a user will be close to the center of a spatial region supported by 2 atlases. Through it, a margin according to a user's left and right spatial movement may be secured. In other words, as a bitstream for an atlas for a view when a user's movement is expected is continuously received, it is possible to reproduce a seamless viewport image. In addition, by additionally receiving and decoding a neighboring atlas, an occlusion region may be interpolated through surrounding view images when synthesizing a view image.

Meanwhile, in FIG. 5, it was described by taking as an example a case in which multiview images are acquired from omnidirectional cameras arranged in a horizontal direction, but even when omnidirectional cameras are arranged in a vertical direction, are arranged in a vertical and horizontal direction, or are arranged in a spherical shape, it can be said that the above-described embodiment may be applied.

In addition, through an atlas selection unit, it is possible to input to a MIV decoder only an atlas required to reproduce a viewport image among a plurality of atlases reconstructed through an image decoder.

FIG. 6 is a flow chart of an atlas switching method according to an embodiment of the present disclosure.

First, a terminal may selectively receive 2 atlases according to a watching space of a user S610. 2 atlases may be a first atlas including a view corresponding to a watching space of a user and a second atlas neighboring it. When there are a plurality of neighboring atlases in a first atlas, one of the plurality of neighboring atlases may be selected by comparing a distance between the watching space and the center of a spatial region supported by each of the neighboring atlases with the first atlas.

When it is determined that switching of a received atlas is required S620, an atlas including a view image corresponding to a viewport image is maintained as it is (i.e., is continuously received), while switching is performed for a neighboring atlas S630. In other words, while a first atlas corresponding to a viewport image is received as it is, reception of a second atlas neighboring a first atlas may be stopped and a third atlas neighboring a first atlas may be newly received.

In this case, whether atlas switching is required may be determined based on at least one of moving speed of a viewer, rotational speed of a viewer, a spatial interval of view images or the number of view images in an atlas.

Unlike a description through FIGS. 5 and 6, it is also possible to receive a plurality of neighboring atlases together with an atlas including a view image corresponding to a viewport image.

FIG. 7 is intended to describe a method of reproducing a viewport image seamlessly according to a viewer's movement according to an embodiment of the present disclosure.

In FIG. 7, unlike FIG. 5, it was illustrated that all of an atlas corresponding to a viewport image, an atlas adjacent to the left of the atlas and an atlas adjacent to the right of the atlas are received. In other words, a plurality of atlases are received, but an atlas in which a current viewport image is included may be set to be spatially positioned at the center of a plurality of atlases.

For implementation of embodiments described in the present disclosure, a MIV encoder may generate and transmit mapping information on a view image included in each atlas as metadata. The mapping information may include information on at least one mapping relation of an atlas identifier for distinguishing each atlas, a view image identifier for distinguishing each view image or a spatial position of each view image (e.g., an external camera parameter).

A terminal periodically interprets metadata to generate and update information on a mapping relation between an atlas identifier and a view image identifier (e.g., mapping or lookup table). Alternatively, periodically, information representing whether it is required to update a mapping relation between an atlas identifier and a view image identifier may be periodically encoded as metadata and signaled.

Mapping information on an atlas and a view image which are not received in a terminal may be also stored in a terminal through metadata interpretation.

Subsequently, a terminal may match a view image required to render a watching space by tracking a watching position/angle of a user according to passage of time and distinguish an atlas identifier mapped to a view image based on information on a pre-established mapping relation. Subsequently, an atlas may be selectively decoded by requesting a mapped atlas identifier to an edge server or a transmission server.

If an atlas bitstream is selected in an edge server, fewer bitstreams than atlas streams transmitted to an edge server will be input to a terminal and accordingly, a terminal will receive only the smaller amount of data than an edge server. In other words, an edge server receives N bitstreams for N atlases from a transmission server, but a bitstream provided for a terminal may be fewer bitstreams than N.

A name of syntax elements introduced in the above-described embodiments is just temporarily given to describe embodiments according to the present disclosure. Syntax elements may be named differently from what was proposed in the present disclosure.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method of switching an atlas according to a watching position comprising:
obtaining information on a view image required to reproduce a viewport image;
obtaining information of a first atlas mapped to the view image; and
receiving a bitstream of the first atlas and the bitstream of a second atlas different from the first atlas,
wherein it is determined that atlas switching is necessary, reception of any one of the bitstream of the first atlas and the bitstream of the second atlas is stopped and the bitstream of a third atlas is newly received.

2. The method of claim 1, wherein the second atlas is a neighboring atlas neighboring the first atlas, and the neighboring atlas includes a second view image which is spatially adjacent to a first view image included in the first atlas.

3. The method of claim 1, wherein when there are a plurality of neighboring atlases for the first atlas, one of the plurality of neighboring atlases is selected as the second atlas based on a spatial position of the view image corresponding to the viewport image.

4. The method of claim 1, wherein the third atlas neighbors the atlas in which reception is not stopped and does not neighbor the atlas in which reception is stopped among the first atlas and the second atlas.

5. The method of claim 1, wherein whether the switching is required is determined based on at least one of moving speed of a viewer, rotational speed of the viewer, a spatial interval between view images or a number of view images in the atlas.

6. The method of claim 1, wherein the bitstream of the first atlas to the third atlas is received from an edge server, and a number of bitstreams received by the edge server from a transmission server is greater than the number of bitstreams provided by the edge server to a terminal.

7. The method of claim 1, wherein the bitstream of the first atlas to the third atlas is received by a transmission client in a terminal,
wherein a number of bitstreams provided by the transmission client to an image decoder is smaller than the number of bitstreams received by the transmission client.

8. The method of claim 1, wherein a mapping relation between view images and atlases is periodically updated.

9. The method of claim 1, wherein mapping information on more atlases than a number of atlases decoded by a terminal is stored in the terminal,
wherein the mapping information is information on the view image included in the atlas per atlas.

10. A device of switching an atlas according to a watching position comprising:
a MIV decoder configured to:
obtain information on a view image required to reproduce a viewport image, and
obtain information of a first atlas mapped to the view image; and
a bitstream reception unit configured to:
receive a bitstream of the first atlas and the bitstream of a second atlas different from the first atlas,
wherein it is determined that atlas switching is necessary, reception of any one of the bitstream of the first atlas and the bitstream of the second atlas is stopped and the bitstream of a third atlas is newly received.

11. The device of claim 10, wherein the second atlas is a neighboring atlas neighboring the first atlas, and the neighboring atlas includes a second view image which is spatially adjacent to a first view image included in the first atlas.

12. The device of claim 10, wherein when there are a plurality of neighboring atlases for the first atlas, one of the plurality of neighboring atlases is selected as the second atlas based on a spatial position of the view image corresponding to the viewport image.

13. The device of claim 10, wherein the third atlas neighbors the atlas in which reception is not stopped and does not neighbor the atlas in which reception is stopped among the first atlas and the second atlas.

14. The device of claim 10, wherein whether the switching is required is determined based on at least one of moving speed of a viewer, rotational speed of the viewer, a spatial interval between view images or a number of view images in the atlas.

15. The device of claim 10, wherein the bitstream of the first atlas to the third atlas is received from an edge server, and a number of bitstreams received by the edge server from a transmission server is greater than the number of bitstreams provided by the edge server to a terminal.

16. The device of claim 10, wherein the device further includes an image decoder which decodes the bitstream,
wherein a number of bitstreams provided by the bitstream reception unit to the image decoder is smaller than the number of bitstreams received by the bitstream reception unit.

17. The device of claim 10, wherein a mapping relation between view images and atlases is periodically updated.

18. The method of claim 10, wherein mapping information on more atlases than a number of atlases received by the bitstream reception unit is stored in the device,
wherein the mapping information is information on the view image included in the atlas per atlas.
